(19) United States
(12) Patent Application Publication
(10) Pub. No.: US 2015/0248806 A1
(43) Pub. Date: Sep. 3, 2015

(54) MOBILE LOTTERY SYSTEM AND METHODS FOR OPERATING SAME

(71) Applicant: Shoutz, Inc., Austin, TX (US)

(72) Inventor: James G. Mueller, Austin, TX (US)

(73) Assignee: Shoutz, Inc., Austin, TX (US)

(21) Appl. No.: 14/636,090

(22) Filed: Mar. 2, 2015

Related U.S. Application Data
(60) Provisional application No. 61/946,749, filed on Mar. 1, 2014.

(51) Int. Cl. G07F 17/32; G07F 17/42

(52) U.S. Cl. CPC G07F 17/329; G07F 17/3209; G07F 17/42

(57) ABSTRACT

Method and system is disclosed for operating one or more lottery-based games. The method includes authenticating and registering a mobile device for processing end user sales and lottery ticket redemption, generating and displaying a user interface allowing a player to make the player selections associated with a type of lottery ticket associated with a player selected lottery game, wherein the player selections are associated with a first set of operating parameters when the mobile device is connected to a network and associated with a second set of operating parameters when the mobile device is disconnected to the network, receiving input from a player corresponding to the player selections for the lottery ticket, generating an order for the lottery ticket including the player selections, and printing the lottery ticket.

### CROSS REFERENCE TO RELATED APPLICATIONS

This application claims the benefit of U.S. Provisional Application No. 61/946,749 filed on Mar. 1, 2014 which is hereby incorporated herein by reference.

### TECHNICAL FIELD

This disclosure relates to a platform for selling lottery tickets and other games of chance, and more specifically to a self-contained mobile platform capable of allowing players to purchase and participate in lottery and chance-based games.

### BACKGROUND

The statements in this section merely provide background information related to the present disclosure and may not constitute prior art.

Lotteries are important sources of revenue for many governments. Historically, regional and national lotteries typically require significant infrastructure and physical resources. Known systems utilize specialized lottery terminals in licensed retailers. These terminals are used to print a player a set of numbers they select or use a “quick pick” system for each particular game. Information associated with sold tickets, e.g., playing numbers, are transmitted to central services for data storage. The retailer collects the cost of the ticket(s).

The need for costly infrastructure poses a barrier to remote or less developed regions or resource-depleted governmental bodies attempting to increase lottery revenue. Financially disadvantaged governmental bodies are also less likely to have the necessary communications infrastructure and more likely to have fewer stores that could serve as retail outlets. Even for regions with well-developed retail sales networks, the fixed nature of lottery sales causes lotteries to miss opportunities to sell tickets at sporadic and occasional events and large gatherings away from retail outlets, e.g., a conference or concert.

Therefore, a need exists for a mobile lottery system that operates in consideration of network relatability and connectivity.

### SUMMARY

Method and system is disclosed for administering and operating a mobile lottery retail platform. The method includes authenticating and registering a mobile device for processing end user sales and lottery ticket redemption, generating and displaying a user interface allowing a player to make the player selections associated with a type of lottery ticket associated with a player selected lottery game, wherein the player selections are associated with a first set of operating parameters when the mobile device is connected to a network and associated with a second set of operating parameters when the mobile device is disconnected to the network, receiving input from a player corresponding to the player selections for the lottery ticket, generating an order for the lottery ticket including the player selections, and printing the lottery ticket.

Certain embodiments of the invention include a feature of administering a lottery-based system that includes authenticating and registering a plurality of mobile devices for processing end user sales and lottery ticket redemption, associating each of the plurality of mobile devices with one or more system roles, receiving information associated with lottery ticket sales from one or more of the plurality of mobile devices having permission to sell lottery tickets, wherein the received information includes wager totals and collected sales; determining a maximum wager and maximum exposure limit for a selected mobile device based upon the received information, receiving input from a player corresponding to player selections for the lottery ticket, wherein the player selections are made from a first set of operating parameters when the mobile device is connected to a network and associated with a second set of operating parameters when the mobile device is disconnected to the network, receiving an order for the lottery ticket including the player selections, and executing the lottery-based game associated with the ordered lottery ticket.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows a mobile lottery system, in accordance with the present disclosure;

FIG. 2 shows an exemplary server system, in accordance with the present disclosure;

FIG. 3 shows an exemplary process for operating the lottery system, in accordance with the present disclosure;

FIGS. 4A and 4B show exemplary user interfaces allowing a player to make the player selections associated with a type of lottery ticket associated with a player selected lottery game, in accordance with the present disclosure;

FIG. 5 shows an exemplary table showing information associated with each lottery game operated by the system, in accordance with the present disclosure;

FIG. 6 shows an exemplary user management interface for an admin-user, in accordance with the present disclosure;

FIG. 7 shows an exemplary interface for adding a user to the system, in accordance with the present disclosure;

FIG. 8 shows an exemplary interface for adding a user entity to the system, in accordance with the present disclosure;

FIG. 9 shows an exemplary interface for setting a user role to the system, in accordance with the present disclosure;

FIG. 10 shows an exemplary interface for managing roles associated with a selected user, in accordance with the present disclosure; and

FIG. 11 shows an exemplary interface for displaying information associated with mobile devices within the system, in accordance with the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Furthermore, as used herein, numerical ordinals such as “first,” “second,” “third,” etc., such as first, second, and third components, simply denote different singles of a plurality unless specifically defined by language in the appended claims.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

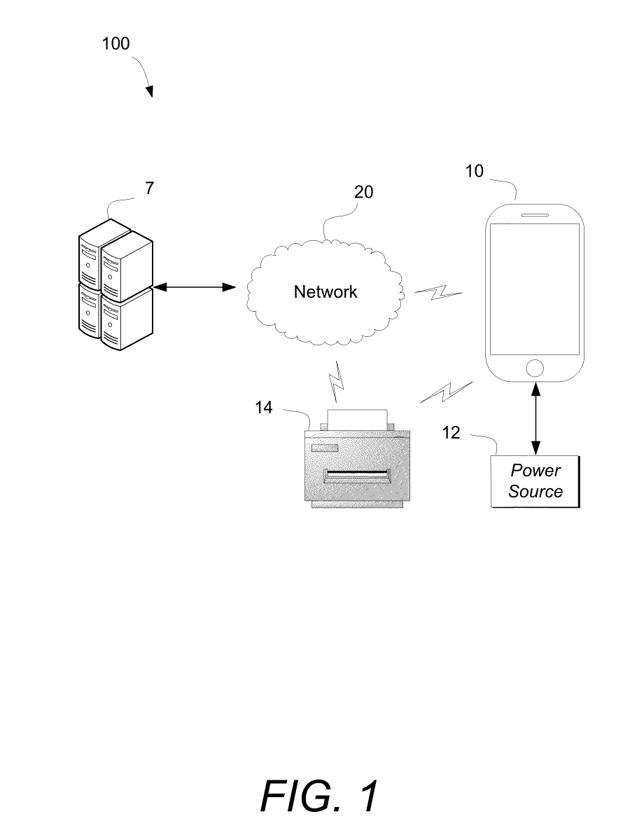

Referring now to the drawings, wherein the depictions are for the purpose of illustrating certain exemplary embodiments only and not for the purpose of limiting the same, FIG. 1 schematically shows an exemplary mobile lottery system 100 that may help implement the methodologies of the present disclosure. The system 100 includes a server system 7, a network 20, one or more mobile devices 10, and one or more printers 14, each printer paired to a mobile device of the one or more mobile devices 10. One or more of the printers 14 may be a thermal printer.

As FIG. 1 shows, the server system 7 may be directly communicatively connected to the network 20. The mobile device 10 may be physically connected to the network 20 during selected periods of operation without departing from the teachings herein. Each mobile device is paired with a printer 14. The pairing may be wired, wireless and/or through the network 20. Components of the system 100 are shown in FIG. 1 as single elements. Such illustration is for ease of description and it should be recognized that the system 100 may include multiple additional mobile and computing devices.

The network 20 may be any suitable series of points or nodes interconnected by communication paths. The network 20 may be interconnected with other networks and contain sub networks network such as, for example, a publicly accessible distributed network like the Internet or other telecommunications networks (e.g., intranets, virtual nets, overlay networks and the like). The network 20 may facilitates the exchange of data between and among one or more mobile devices 10 and the server system 7.

The server system 7 may be: various embodiments of a computer including high-speed microcomputers, minicomputers, mainframes, and/or data storage devices. The server system 7 preferably executes database functions including storing and maintaining a database and processes requests from each mobile device 10 to extract data from, or update, a database as described herein below. The server 7 may additionally provide processing functions for the mobile device 10 as will become apparent to those skilled in the art upon a careful reading of the teachings herein.

In one or more implementations, the mobile device 10 is a mobile phone. However, the mobile device 10 may be another type of portable device, such as a smartphone, cell phone, tablet computer, any wireless-enabled wearable device, laptop computer, netbook computer, or the like. It is contemplated by the disclosure herein that many different types of portable devices may be used concurrently within the system 100, in various embodiments. In some implementations, one or more of the mobile devices 10 includes a port device, e.g., a Universal Serial Bus (USB) port, or a docking port, or some other wired port connection. The port device can, for example, be utilized to establish a wired connection to the printer 14. In various embodiments, one or more mobile devices 10 can include wireless network adapters for wireless communications using one or more wireless communications protocols to the printer 14. Wireless communications to the printer 14 can be executed using short-wavelength radio transmissions, separate from cellular-based radio communications from which one or more mobile devices 10 may concurrently utilize. In one embodiment, the mobile device includes a credit card reader or scanner, e.g., RFID.

In addition, the mobile device 10 may include one or more applications that the user may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

The mobile device 10 may be connected to an external power supply 12. The power supply 12 may be any suitable device for powering the mobile device 10. For example, the power supply 12 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like configured to supply a charge to the mobile device 10. The power supply 12 enables the mobile device user, e.g., the lottery retailer, to operate in areas without ready access, unreliable to electricity.

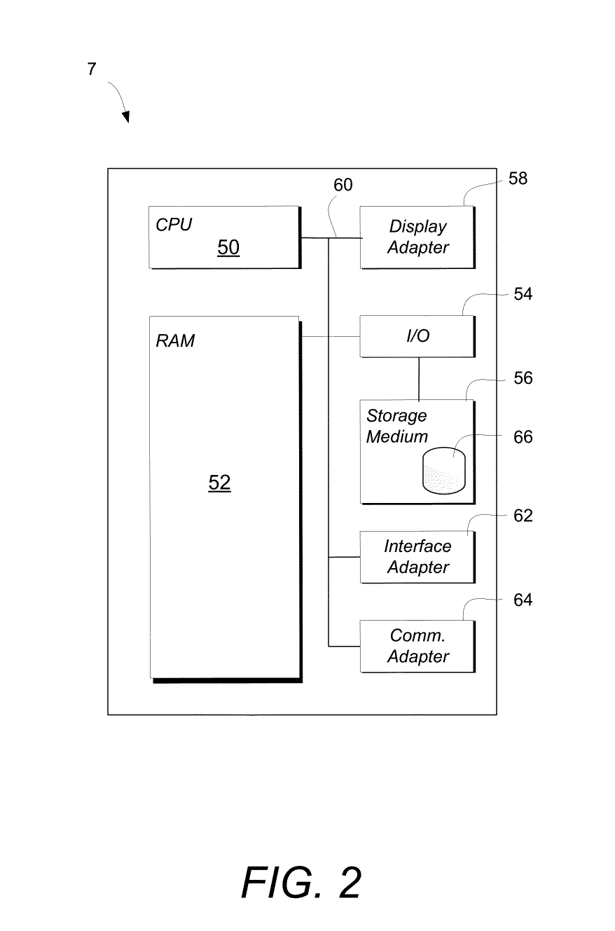

FIG. 2 shows the exemplary server system 7. The server system 7 includes a central processing unit (CPU) 50, random access memory (RAM) 52, input/output circuitry 54 for connecting peripheral devices such as a storage medium 56 to a system bus 60, a display adapter 58 for connecting the system bus 60 to a display device, a user interface adapter 62 for connecting user input devices such as a keyboard, a mouse, and/or a microphone, to the system bus 60, and a communication adapter 64 for connecting the computing device 5 to the network 20. In one embodiment, the communication adapter 64 is a wireless adapter configured for extraterrestrial communication such as in a communications satellite. The storage medium 56 is configured to store, access, and modify a database 66, and is preferably configured to store, access, and modify structured or unstructured databases for data including, for example, relational data, tabular data, audio/video data, and graphical data.

The central processing unit 50 is preferably one or more general-purpose microprocessor or central processing unit(s) and has a set of control algorithms, comprising resident program instructions and calibrations stored in the memory 52 and executed to provide the desired functions. In one embodiment, an application program interface (API) is preferably executed by the operating system for computer applications to make requests of the operating system or other computer applications. The description of the central processing unit 50 is meant to be illustrative, and not restrictive to the disclosure, and those skilled in the art will appreciate that the disclosure may also be implemented on various operating systems.

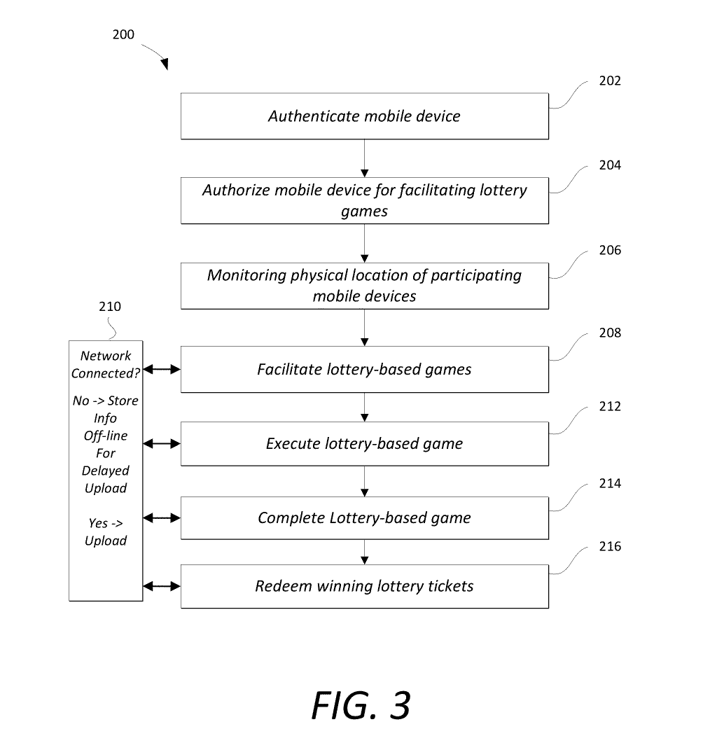

FIG. 3 shows an exemplary process 200 for operating the lottery system 100. As FIG. 3 shows, the process is initiated at step 202 whereby the server system 7 authenticates a registered mobile device 10. Users and mobile devices may be authenticated using supplied digital signature, biometric identification, or any other digital credential, e.g., user identification and passcode. In one embodiment, positioning information is required for authentication, e.g., positioning information associated with a particular, defined zone. Digital credentials can include any sort of digital signature or other identifier (e.g., a serial number, MAC address, and/or the like). Such information may be compared against information stored in database 66 or elsewhere as desired. If authentication is granted, then the connection between the server system 7 and the mobile device 10 can be established. In various embodiments, data stored within database 66 can be used to discontinue the connection according to appropriate rules to ensure compliance with lottery-based rules. In some embodiments, it may be desirable to discontinue all connections after a pre-determined period of time or after a pre-determined amount of data has been processed. The particular rules and parameters implemented will vary from embodiment to embodiment and any number of rules could be implemented using the rules engine of database 66 as desired.

Subsequent to successful authentication, the mobile device 10 is authorized to sell lottery tickets for one or more lottery games based upon an agent profile associated with the agent 204. The server system 7 manages one or more lottery games by communicating with one or more of the mobile devices 10. The mobile devices 10 executes a lottery purchasing program consists of game-specific modules, for example a lottery module or instant win module, a number entry or selection module, a payment module and a number submission module.

At step 206, the system 7 monitors one or more operating parameters of the mobile device 10 for compliance with lottery rules. For example, the system 7 may monitor physical location of the participating mobile devices.

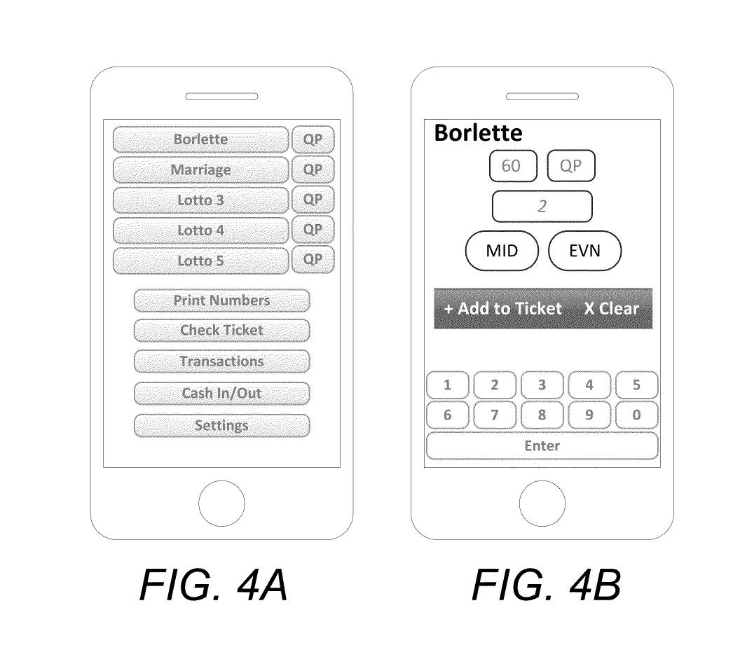

At step 208, the system 7 facilitates one or more of the lottery-based games. Selection of the lottery-based game may be made by a player-user using, for example, a user interfaces such as shown in FIG. 4A. Facilitation of one or more of the lottery-based games may include managing payment accounts with the lottery or lottery operator. The payment account may be associated with a credit card of the lottery retailer, may be an unsecured line of credit, or may be prepaid by the lottery retailer. This account information may be maintained remotely on the lottery operations servers and may also be stored locally on the platform.

At step 210, the mobile device 10 determines if the connection between the server 7 and the device 10 is connected. At various points in the process 200, the system 100 may perform a connection test, including steps 212, 214, and 216, before sending or storing information off-line as results of the tests may dictate. If the platform is connected to a network the transaction will immediately process. If the platform is not connected, the transaction information is saved and the transaction completed later. Upon establishing a reliable network connection, e.g., network connected for a predefined time period, lottery-based information including payment information, e.g., credit card data, and game-play data such as number information can be immediately transmitted back to the server 7. The lottery retailer delivers the proceeds from the ticket or instant win game sales and the server registers the numbers. In various embodiments, if it is not possible to connect the mobile device to the server 7, either via a network 20 or directly, the lottery retailer of the mobile device 10 can also transfer the stored information to a storage device, for instance a USB drive, or can print out all of the saved numbers using the printer 14. The information can then be subsequently hand-keyed into the lottery server 7.

At step 212, the system 7 executes the lottery-based game including receiving input from a player-user corresponding to the player selections for the lottery ticket associated with a selected lottery-game. Game play of the lottery-based game may include player-selection of either a randomly picked lottery number game or selection of a player-supplied numbers lottery game as input from the player-user. The player-supplied numbers may be entered into the mobile device by the lottery player or lottery retailer using, for example a user interface such as that shown in exemplary FIG. 4B. Game play may include selling a desired quantity of tickets or instant win games to a player. The lottery player then verifies the numbers and completes the transaction. In one embodiment, a lottery ticket or tickets are printed with the player's lottery numbers.

At step 214, the lottery game is completed. In one embodiment, the lottery game is completed by the system 100 by selection of numbers for a particular lottery game. For example, in a draw three lottery game, the system 100 randomly selects three numbers from a pool of numbers according to the rules of the game. Winning lottery players are players having lottery tickets that match a predetermined quantity of the selected number, for example all three randomly selected numbers. For winning lottery tickets, the payment may be made in cash, credit card, debit card or pre-paid card or any other forms of value or currency 216.

In one embodiment, the lottery player may also choose to set up an account on the platform. An electronic ticket with specific numbers may be stored in the purchaser's account on the platform. As an added inducement to purchase lottery tickets, the lottery player may be entered into a second chance drawing, a drawing to win additional prizes.

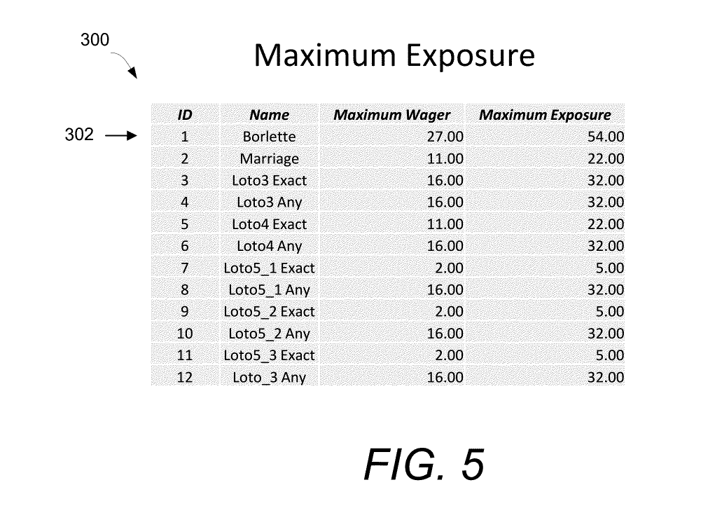

FIG. 5 shows an exemplary table 300 showing information associated with each lottery game operated by the system 100. As FIG. 5 shows, the table includes information associated with a lottery game identification (‘Id’), a lottery game name (‘Name’), a maximum wager (‘Maximum Wager’), and a maximum exposure (‘Maximum Exposure’). The system 100 is configured to execute lottery-based games within various operating parameters including wager limits and liability exposure limits associated with an agent or device. In one embodiment, maximum wager and maximum exposure limits associated with a particular devices are determined by the system 100 based upon any one of: (1) lottery tickets sales; (2) receive payments; (3) historical and near-term network connection reliability; (4) type of payments received, e.g., electronic payments or physical currency. In one embodiment, a threshold for maximum exposure limits associated with reception of electronic payments are greater than a threshold corresponding to mobile devices having physical currency payments. In one embodiment, wager limits may be associated with a particular lottery-based game. In one embodiment, wager limits may be associated with a particular user. In one embodiment, wager limits may be associated with a particular mobile device. In one embodiment, maximum exposure limits may be associated with a particular game type. In one embodiment, maximum exposure limits may be associated with a particular user or particular mobile device. In one embodiment, an admin-user may selectably modify maximum wager limits and maximum exposure limits for a particular, selected agent-user, a mobile device, or by lottery-game type.

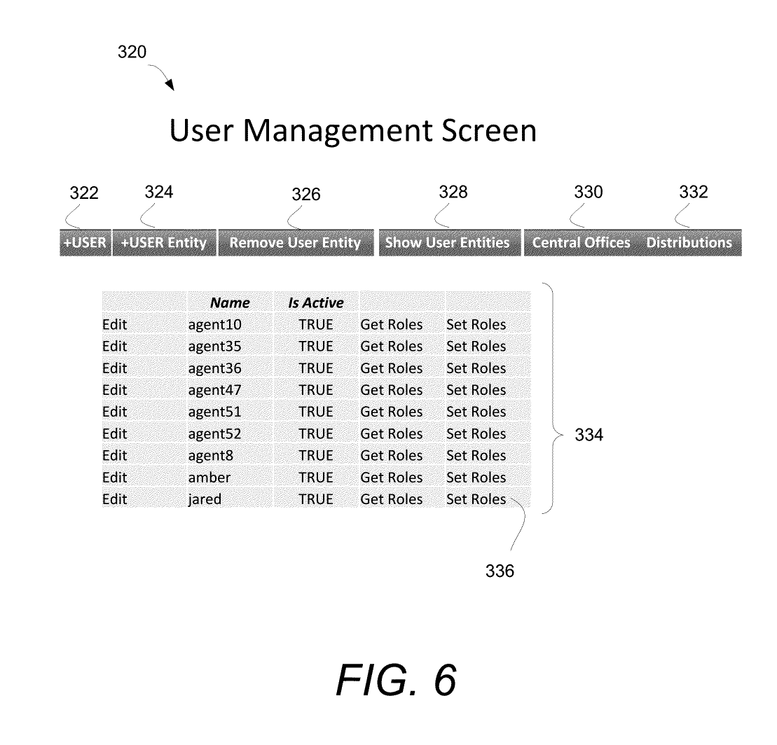

FIG. 6 shows an exemplary user management interface 320 for an admin-user. As FIG. 6 show, the admin user may add a user 322, add a user entity 324, remove a user entity 326, display user entities 328, display central offices associated with components of the lottery system 330, and display distributions 332. Table 334 shows exemplary data associated with the user management interface 320. From the table 334, an admin-user may edit objects, permissions, information, and roles associated for a selected user. For example, the admin-user may deactivate a user, assign or remove a user role, e.g., agent, administrator, etc., display roles associated with a user, and set roles.

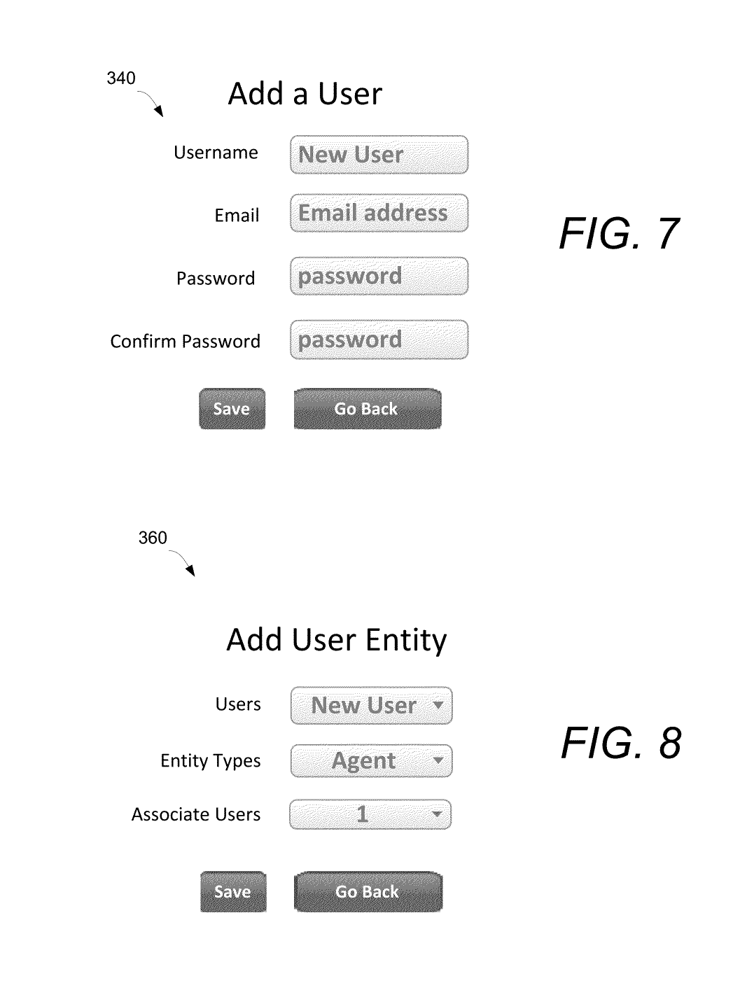

FIG. 7 shows an interface 340 associated with selection of a navigational button 322 corresponding to adding a user to the system 100. As FIG. 7 shows, the system 100 is configured to add new users. In one embodiment, adding a new user includes supplying a user name, an email address, and a password. The admin-user may then actuate the ‘save’ navigational button to complete the addition.

FIG. 8 shows an interface 360 associated with selection of a navigational button 324 corresponding to adding a user entity to the system 100. As FIG. 8 shows, an admin-user may add a user entity for association to a selected user by: (1) selecting a user from a dropdown list of users; (2) selecting the entity type for the selected user, and (3) selecting the user to associate to the selected user, e.g., user (1′). The admin-user may then actuate the ‘save’ navigational button to set the user entity assignment.

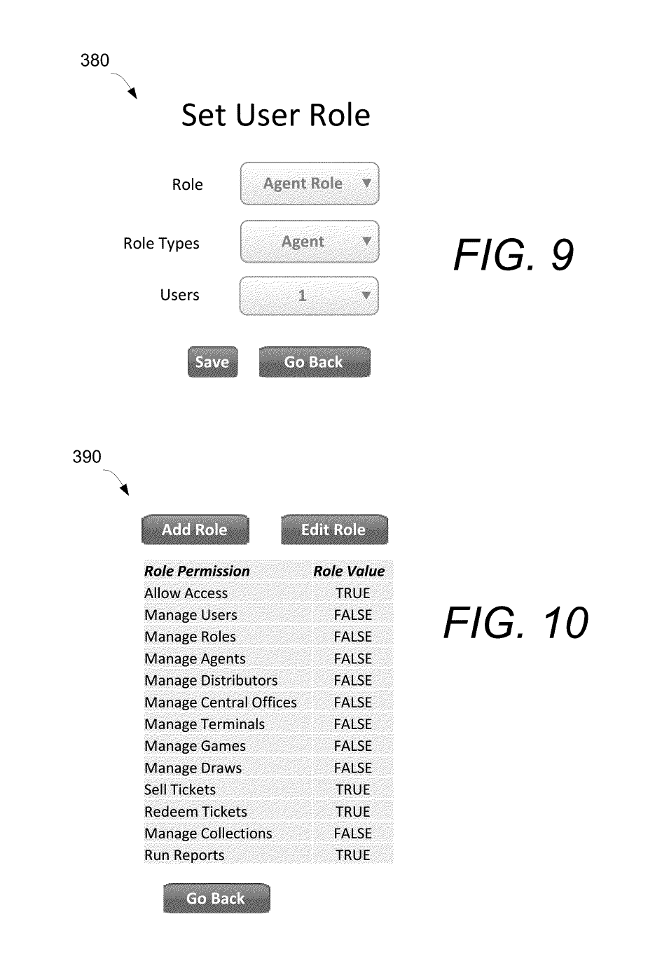

FIG. 9 shows an interface 380 associated with selection of a navigational button 326 corresponding to setting a user role to the system 100. As FIG. 9 shows, an admin user may add a user role for a selected user by: (1) selected a role identification to assign; (2) selecting a role type to assign; and (3) selecting a desired user, user (1′). The admin-user may then actuate the ‘save’ navigational button to set the role assignment.

FIG. 10 shows an exemplary interface 390 for managing roles associated with a selected user. In one embodiment, an admin-user may navigate to the interface 390 by actuating a navigational feature within the user management interface 320 associated with a desired user, e.g., a hyperlinked ‘Set Roles’ as shown in element 336 of FIG. 6. As FIG. 10 shows, a particular user may be associated with one or more roles. In one embodiment, the roles are delineated in a Boolean-type structure having a ‘TRUE’ or ‘FALSE’ state. Role permissions for a particular user can include one or more of: (1) Allow access; (2) Manage Users; (3) Manage Roles; (4) Manage Agents; (5) Manage Distributors; (6) Manage Central Offices; (7) Manage Terminals; (8) Manage Games; (9) Sell Tickets; (10) Redeem Tickets; (11) Manage Collections; and (12) Run Reports. The interface 390, in one embodiment, displays the current role permissions set for the selected user. Additional role permissions can be assigned to the selected user by selecting an ‘Add Role’ navigational button and creating a new role, or by selecting ‘Edit Role’ and editing the current role permissions.

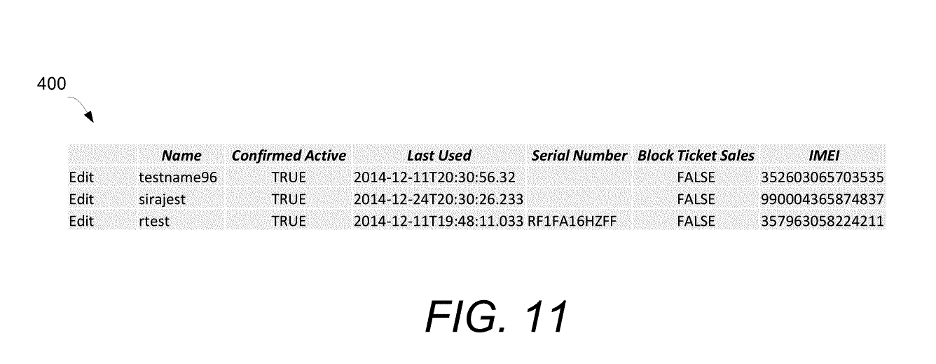

FIG. 11 shows an exemplary interface 400 for displaying information associated with mobile devices 10 within the system 100. As FIG. 11 shows, the interface may show an identifying name (‘Name’) associated with the mobile device, a mobile device status (‘Confirmed Active’) within the system 100, time and date information associated with use in the system (‘Last Used’), a serial number, permission to execute block ticket sales, and International Mobile Equipment Identity (‘IMEI’) number. In one embodiment, the interface is configured to enable selective editing of a selected user via a navigational button such as a hyperlink. As FIG. 11 shows, each row of the interface includes an edit hyperlink that is associated with navigation to functions for managing information associated with the device.

The disclosure has described certain preferred embodiments and modifications thereto. Further modifications and alterations may occur to others upon reading and understanding the specification. Therefore, it is intended that the disclosure not be limited to the particular embodiment(s) disclosed for carrying out this disclosure, but that the disclosure will include all embodiments falling within the scope of the appended claims.

1. Method for operating one or more lottery-based games, the method comprising:
authenticating and registering a mobile device for processing end user sales and lottery ticket redemption;
generating and displaying a user interface allowing a player to make the player selections associated with a type of lottery ticket associated with a player selected lottery game, wherein the player selections are associated with a first set of operating parameters when the mobile device is connected to a network and associated with a second set of operating parameters when the mobile device is disconnected to the network;
receiving input from a player corresponding to the player selections for the lottery ticket;
generating an order for the lottery ticket including the player selections; and
printing the lottery ticket.

2. The method of claim 1, wherein the first set of operating parameters includes a maximum wager corresponding to a first threshold and the second set of operating parameters includes a maximum wager corresponding to a second threshold.

3. The method of claim 2, wherein the first threshold is greater than the second threshold.

4. The method of claim 1, wherein the first set of operating parameters includes a maximum wager quantity corresponding to a first threshold and the second set of operating parameters includes a maximum wager quantity corresponding to a second threshold.

5. The method of claim 4, wherein the first threshold is greater than the second threshold.

6. The method of claim 1, further comprising:
uploading information associated with the received input from the player to a server system;
receiving information associated with a lottery game event including lottery numbers; and
redeeming lottery tickets based upon the received information associated with the lottery-game event.

7. The method of claim 6, wherein the first set of operating parameters includes a maximum redemption quantity corresponding to a first threshold and the second set of operating parameters includes a maximum redemption quantity corresponding to a second threshold.

8. The method of claim 7, wherein the first threshold is greater than the second threshold.

9. The method of claim 6, wherein a first prize is associated with redemption of winning lottery tickets and a second prize is associated with redemption of losing lottery tickets.

10. Method for administering a lottery-based system, the method comprising:
authenticating and registering a plurality of mobile devices for processing end user sales and lottery ticket redemption;
associating each of the plurality of mobile devices with one or more system roles;
receiving information associated with lottery ticket sales from one or more of the plurality of mobile devices having permission to sell lottery tickets, wherein the received information includes wager totals and collected sales;
determining a maximum wager and maximum exposure limit for a selected mobile device based upon the received information;
receiving input from a player corresponding to player selections for the lottery ticket, wherein the player selections are made from a first set of operating parameters when the mobile device is connected to a network and associated with a second set of operating parameters when the mobile device is disconnected to the network;
receiving an order for the lottery ticket including the player selections; and
executing the lottery-based game associated with the ordered lottery ticket.

11. The method of claim 10, wherein the one or more system roles are selected from a group including one or more of (1) Allow access; (2) Manage Users; (3) Manage Roles; (4) Manage Agents; (5) Manage Distributors; (6) Manage Central Offices; (7) Manage Terminals; (8) Manage Games; (9) Sell Tickets; (10) Redeem Tickets; (11) Manage Collections; and (12) Run Reports.

12. The method of claim 10, wherein the maximum wager limits are determined in part based upon lottery tickets sales.

13. The method of claim 10, wherein the maximum wager limits are determined in part based upon receive payments.

14. The method of claim 10, wherein the maximum wager limits are determined in part based upon historical and near-term network connection reliability.

15. The method of claim 10, wherein the maximum wager limits are determined in part based upon payment type, wherein a first maximum wager threshold is associated with electronic payments and a second maximum wager threshold is associated with physical currency payments.

16. The method of claim 15, wherein the maximum wager limits are further determined based upon a metric associated with network connection reliability.
